(19) United States
(12) Patent Application Publication
(10) Pub. No.: US 2015/0062436 A1
(43) Pub. Date: Mar. 5, 2015

(54) METHOD FOR VIDEO RECORDING AND ELECTRONIC DEVICE THEREOF

(71) Applicant: Samsung Electronics CO., Ltd., Suwon-si (KR)

(72) Inventors: Sung-Wook AN, Suwon-si (KR); Woo-Hyun BAEK, Suwon-si (KR)

(73) Assignee: Samsung Electronics CO., Ltd., Suwon-si (KR)

(21) Appl. No.: 14/247,678

(22) Filed: Apr. 8, 2014

(30) Foreign Application Priority Data
Aug. 29, 2013 (KR) 10-2013-0103359

(51) Int. Cl. H04N 5/92

(52) U.S. Cl. CPC H04N 5/92
USPC 348/715

(57) ABSTRACT

A method of operating an electronic device capable of video recording is provided. The method includes combining a plurality of frames of video being recorded, displaying the combined frame via a preview screen, and encoding the combined frame.

### CROSS-REFERENCE TO RELATED APPLICATION

This application claims the benefit under 35 U.S.C. §119(a) of a Korean patent application filed on Aug. 29, 2013 in the Korean Intellectual Property Office and assigned Serial number 10-2013-0103359, the entire disclosure of which is hereby incorporated by reference.

### TECHNICAL FIELD

The present disclosure relates to a method for video recording and an electronic device thereof.

### BACKGROUND

Various types of electronic devices are becoming more common in modern society, and there is a tendency to integrate existing individual devices. A technology of a portable electronic device has recently been developed towards mobile phones which provide not only data communication but also functions of separate devices such as a camera, a camcorder, etc., in addition to a standard telephone function.

Various electronic devices as well as the mobile phone can now provide a video recording function. In the video recording, the electronic device uses a sensor to recognize a light beam which is input through a lens, and stores an image, recognized by the use of the sensor, as digital data. In this case, the image to be recorded is processed in the electronic device after the image is input. However, the quality of the image may vary depending on an external environment (e.g., illumination, etc.) to which a subject is exposed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and method for video recording in an electronic device.

Another aspect of the present disclosure is to provide an apparatus and method for improving image quality when video recording is performed in an electronic device.

Another aspect of the present disclosure is to provide an apparatus and method for overcoming a low-illumination environment by using a preview image in an electronic device.

Another aspect of the present disclosure is to provide an apparatus and method for improving a brightness of a low-illumination image by combining frames in an electronic device.

Another aspect of the present disclosure is to provide an apparatus and method for determining an operation parameter to overcome a low-illumination environment in an electronic device.

Another aspect of the present disclosure is to provide an apparatus and method for determining whether to perform an image improvement function to overcome a low-illumination environment in an electronic device.

In accordance with an aspect of the present disclosure, a method of operating an electronic device capable of video recording is provided. The method includes combining a plurality of frames of video being recorded, displaying the combined frame via a preview screen, and encoding the combined frame.

In accordance with another aspect of the present disclosure, an electronic device capable of video recording is provided. The electronic device includes a processor configured to combine a plurality of frames of video being recorded, and to encode the combined frame, and a display unit configured to display the combined frame via a preview screen.

In accordance with another aspect of the present disclosure, an electronic device configured to record video is provided. The electronic device includes at least one processor, and a memory configured to store a software module executed by the at least one processor, wherein the software module includes an instruction set for combining a plurality of frames of video being recorded, for displaying the combined frame via a preview screen, and for encoding the combined frame.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a conceptual view illustrating video frame processing in an electronic device according to an embodiment of the present disclosure;

FIG. 2 illustrates a relation between an input frame and an output frame in an electronic device according to an embodiment of the present disclosure;

FIG. 3 is a functional block diagram for low-illumination improvement processing in an electronic device according to an embodiment of the present disclosure;

FIG. 4 is a block diagram for low-illumination improvement processing in an electronic device according to an embodiment of the present disclosure;

FIG. 5 is a block diagram illustrating low-illumination improvement processing in an electronic device according to an embodiment of the present disclosure;

FIG. 6 is a block diagram illustrating low-illumination improvement processing in an electronic device according to an embodiment of the present disclosure;

FIG. 7 is a block diagram illustrating low-illumination improvement processing in an electronic device according to an embodiment of the present disclosure;

FIG. 8 illustrates an example of combining a frame in an electronic device according to an embodiment of the present disclosure;

FIG. 9 illustrates a process of operating an electronic device according to an embodiment of the present disclosure;

FIG. 10 illustrates a process of operating an electronic device according to an embodiment of the present disclosure;

FIG. 11 is a flowchart illustrating an operation of an electronic device according to an embodiment of the present disclosure; and

FIG. 12 is a block diagram of an electronic device according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The present disclosure described hereinafter relates to a technique for processing a low-illumination image when video recording is performed in an electronic device. In the present disclosure, the electronic device may be a portable electronic device, and may be one of a smart phone, a portable terminal, a mobile phone, a mobile pad, a media player, a tablet computer, a handheld computer, and a Personal Digital Assistant (PDA). In addition, the electronic device may be a device which combines two or more functions from among the aforementioned devices.

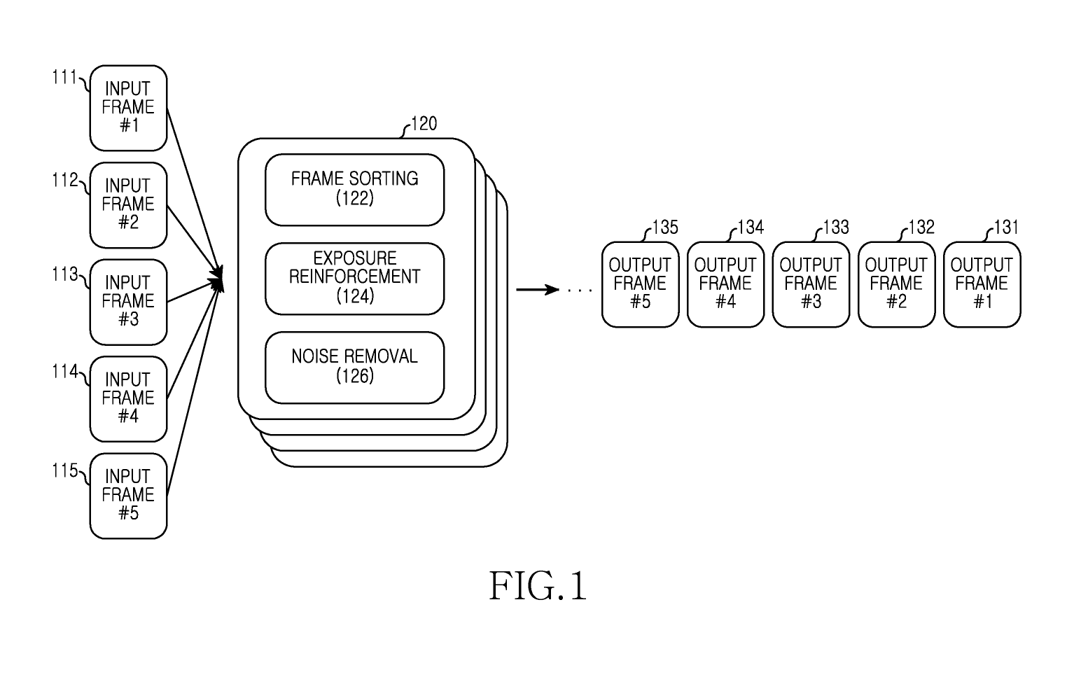

FIG. 1 is a conceptual view illustrating video frame processing in an electronic device according to an embodiment of the present disclosure.

Referring to FIG. 1, when input frames 111 to 115 are generated, image processing 120 is performed to improve low-illumination quality, and output frames 131 to 135 are output. For convenience of explanation, the ‘image processing performed to improve the low-illumination property’ may be referred to as ‘low-illumination improvement processing’ in the present disclosure.

The input frames 111 to 115 are for a preview screen provided for the convenience of a user during video recording, and are displayed via a display means. The input frames 111 to 115 are distinguished from frames for encoding and recording. However, according to image processing, the input frames 111 to 115 may be used only for a preview, or may be used both for the preview and the encoding. Although only five input frames 111 to 115 are illustrated in FIG. 1, the preview frame is continually generated during video recording.

The low-illumination improvement processing (i.e., image processing) 120 includes frame sorting 122, exposure reinforcement 124, and noise removal 126. The frame sorting 122 includes an operation that an image in a frame is split to combine frames. For example, the frame sorting 122 may be performed by splitting the image according to a pre-set pattern, or may be performed on the basis of an area where motion exists in a frame.

The exposure reinforcement 124 includes an operation to increase an exposure value of the image. The exposure value is a factor related to an intensity of input light in a video recording, an input time length, etc., and is related to a brightness in an output image. That is, the exposure reinforcement 124 includes an operation to increase the brightness of the image. According to the embodiment of the present disclosure, the exposure reinforcement 124 may be performed by combining some or all of the input frames 111 to 115. Herein, the combination includes an operation to estimate a value of a pixel to be input when recording is performed in a higher illumination environment on the basis of outputs analyzed in a unit of pixel or block of images to be combined. For example, the combination may be performed by adding pixel values among a plurality of frames. In the combination, various mechanisms may be applied for the exposure reinforcement through an image combination.

The noise removal 126 includes an operation to decrease a noise in the image. The noise removal 126 may be performed spatially or temporally. For example, the noise removal 126 may be performed through filtering for all pixels of a corresponding frame. More specifically, the filtering may include at least one of a convolution filter, a mean filter, a Gaussian filter, a median filter, and a sigma filter. For example, the mean filter is used to smooth images and to remove a noise in a simple and intuitive manner, and is determined as a result of filtering an average of a small localized window. A specific size or the like of the window may be regulated according to a level of the noise removal 126. For another example, the noise removal 126 may be performed on the basis of a corresponding frame and motion information of neighboring frames. More specifically, pixels are classified into a motion area and a non-motion area, and in case of the non-motion area, filtering is performed on pixels of the corresponding frame and the neighboring frames along a time axis. In this case, the number of frames used in the filtering may be regulated according to the level of the noise removal 126.

The output frames 131 to 135 are outputs of the low-illumination improvement processing 120. Therefore, the output frames 131 to 135 include brighter images in comparison with the input frames 111 to 115. The output frames 131 to 135 are used for a preview, and may also be used for encoding and recording. The number of preview frames used to generate each of the output frames 131 to 135 may vary depending on specific images included in the input frames 111 to 115.

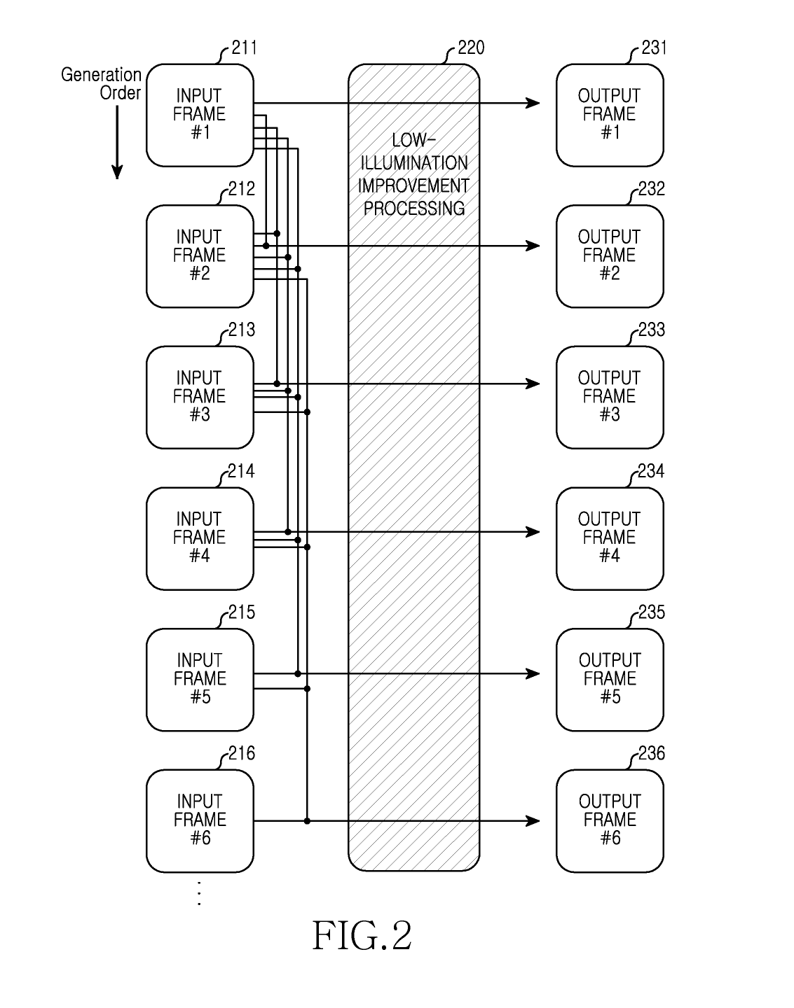

FIG. 2 illustrates a relation between an input frame and an output frame in an electronic device according to an embodiment of the present disclosure.

Referring to FIG. 2, input frames are generated in the order of an input frame#1 211, an input frame#2 212, an input frame#3 213, an input frame#4 214, an input frame#5 215, and an input frame #6 216. According to low-illumination improvement processing 220 of the input frames 211 to 216, output frames are generated in the order of an output frame #1 231, an output frame #2 232, an output frame #3 233, an output frame #4 234, an output frame #5 235, and an output frame #6 236.

Since an image for video recording is processed in the embodiment of the present disclosure, input frames to be processed are continually generated during recording, and thus output frames are also continually generated. That is, unlike image processing for a single image in a still camera, the image processing according to an embodiment of the present disclosure produces continuous inputs and continuous outputs. Accordingly, one input frame may have an effect on the generation of a plurality of output frames. In addition, the number of input frames on the basis of which each output frame is generated may vary.

Referring to FIG. 2, since the input frame#1 211 is a frame which is input first after video recording starts, there is no previous input frame. Therefore, the output frame #1 231 is generated on the basis of only the input frame #1 211. The output frame #2 232 is generated on the basis of the input frame #1 211 and the input frame #2 212, and the output frame #3 233 is generated on the basis of the input frame #1 211, the input frame #2 212, and the input frame #3 213. In addition, the output frame #4 234 is generated on the basis of the input frame #1 211 to the input frame #4 214, and the output frame #5 235 is generated on the basis of the input frame #1 211 to the input frame #5 215. In case of FIG. 2, since one output frame is generated on the basis of five input frames, the output frame #6 236 is generated on the basis of the input frame #2 212 to the input frame #6 216.

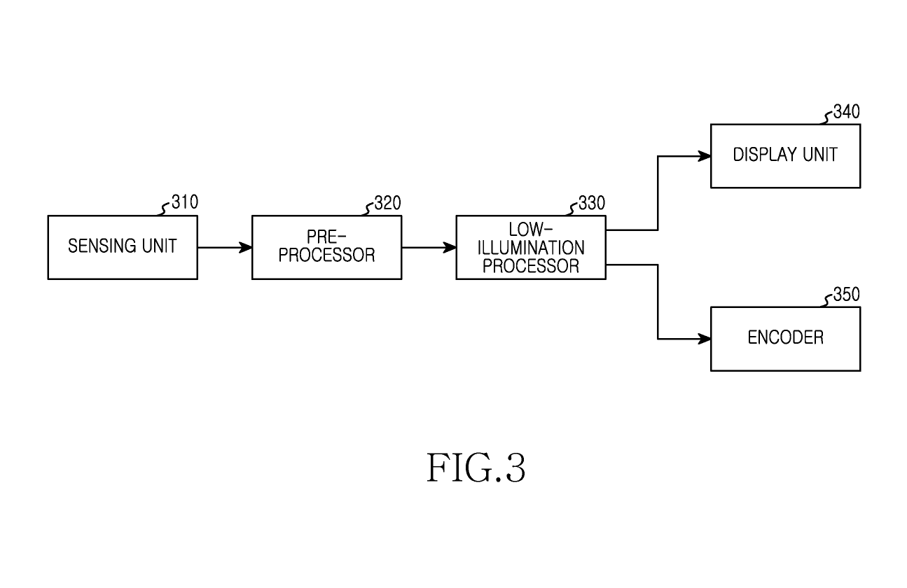

FIG. 3 is a functional block diagram for low-illumination improvement processing in an electronic device according to an embodiment of the present disclosure.

Referring to FIG. 3, the electronic device includes a sensing unit 310, a pre-processor 320, a low-illumination processor 330, a display unit 340, and an encoder 350.

The sensing unit 310 recognizes a light beam which is input through a lens, and digitizes it into data. In other words, the sensing unit 310 converts the input light beam into an electronic signal, and outputs raw data of an image. For example, the sensing unit 310 may include at least one of a Charge Coupled Device (CCD) and a Complementary Metal Oxide Semiconductor (CMOS).

The pre-processor 320 performs processing necessary to encode or display image data provided from the sensing unit 310. For example, the pre-processor 320 performs at least one of scaling and Color Space Conversion (CSC). The scaling includes an operation to regulate a size of the image to a size required for the displaying or the encoding. That is, the pre-processor 320 converts the image size so that preview data fits to a resolution of a display means and so that encoding data fits to an encoding input. The CSC includes an operation to convert a color value with respect to a color input type and display type and an intermediate storage and transmission type. That is, since the color value varies depending on a color model, the pre-processor 320 performs a CSC function for converting a data value according to the color model. For example, the color model may include RGB, YCbCr, HSV, etc. For example, the CSC may be performed through a matrix operation.

The low-illumination processor 330 performs low-illumination improvement processing on an image provided from the pre-processor 320. In other words, the low-illumination processor 330 generates frames including an image brighter than a preview frame which is input, by combining preview frames. In this case, the low-illumination processor 330 may receive a preview frame and a recording frame from the pre-processor 320 via two paths, or may receive a frame via one path.

The display unit 340 is a display means for displaying a frame processed by the low-illumination processor 330. The display unit 340 may include at least one of a Liquid Crystal Display (LCD), a Light Emitting Diode (LED), a Light emitting Polymer Display (LPD), an Organic Light Emitting Diode (OLED), an Active Matrix OLED (AMOLED), and a Flexible LED (FLED). The encoder 350 performs encoding to store the frame processed by the low-illumination processor 330. Although not shown in FIG. 3, a storage unit may be included to store an image encoded by the encoder 350.

Hereinafter, an example of a combination of the pre-processor 320 and the low-illumination processor 330 is described according to the present disclosure.

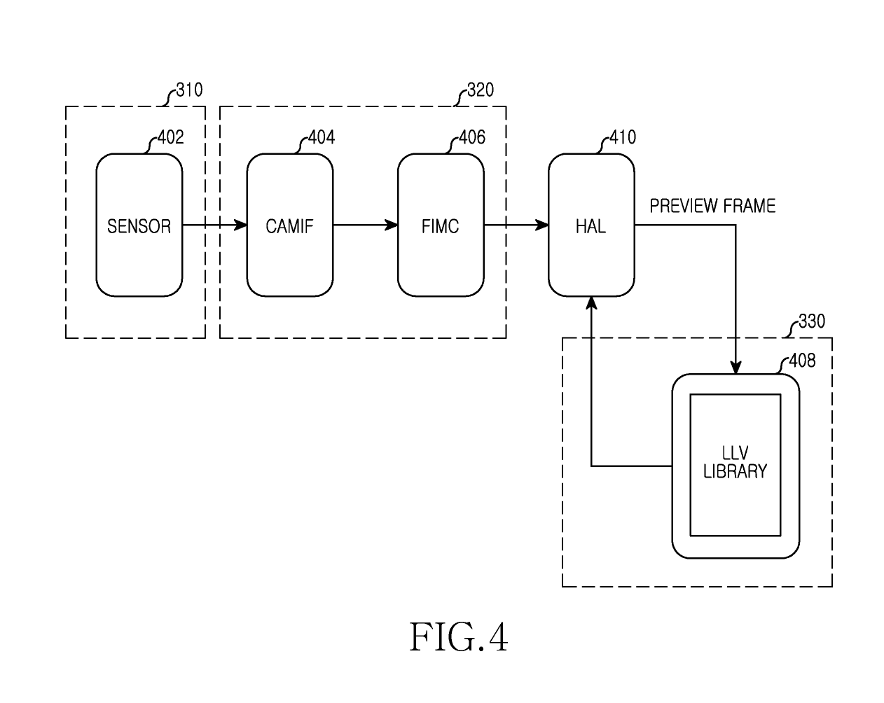

FIG. 4 is a block diagram for low-illumination improvement processing in an electronic device according to an embodiment of the present disclosure.

Referring to FIG. 4, the sensing unit 310 may include a sensor 402. The pre-processor 320 may include a CAMera InterFace (CAMIF) 404 and an Fully Interactive Mobile Camera interface (FIMC) 406. The low-illumination processor 330 may include an Low Light Video (LLV) library 408. An Hardware Abstraction Layer (HAL) 410 may be further included.

As an element for recognizing a light beam which is input through a lens, the sensor 402 may further include at least one of CCD and CMOS. The CAMIF 404 may provide an interface between the sensor 402 and its following processing blocks, and may perform CSC. The FIMC 404 performs a function such as image scaling, etc. The HAL 410 performs a function for delivering video data to another hardware entity, and provides an environment in which other blocks can operate in a device-independent manner. The Low-Illumination Processor 330 may include an LLV Library 408. The LLV library 408 includes a set of instructions for the low-illumination improvement processing described above in FIG. 1 and FIG. 2 or a hardware device which performs a computation according to the instruction.

As illustrated in FIG. 4, a preview frame and a recording frame may be provided via a single path. In this case, the LLV library 408 performs the low-illumination improvement processing on the single path. Accordingly, due to the processing for the single path, the low-illumination improvement processing may be performed for both of the preview frame and the recording frame. That is, the LLV library 408 receives frames from the HAL 410, performs the low-illumination improvement processing, and provides the result back to the HAL 410. Thereafter, although not shown in FIG. 4, the HAL 410 outputs frames which are subjected to the low-illumination improvement processing by a display means and an encoding means.

In case of the embodiment of FIG. 4, the LLV library 408 performs the low-illumination improvement processing for the output of the HAL 410. However, according to another embodiment of the present disclosure, the LLV library 408 may perform the low-illumination improvement processing on the output of the FIMC 406, and may provide the processed frames to the HAL 410.

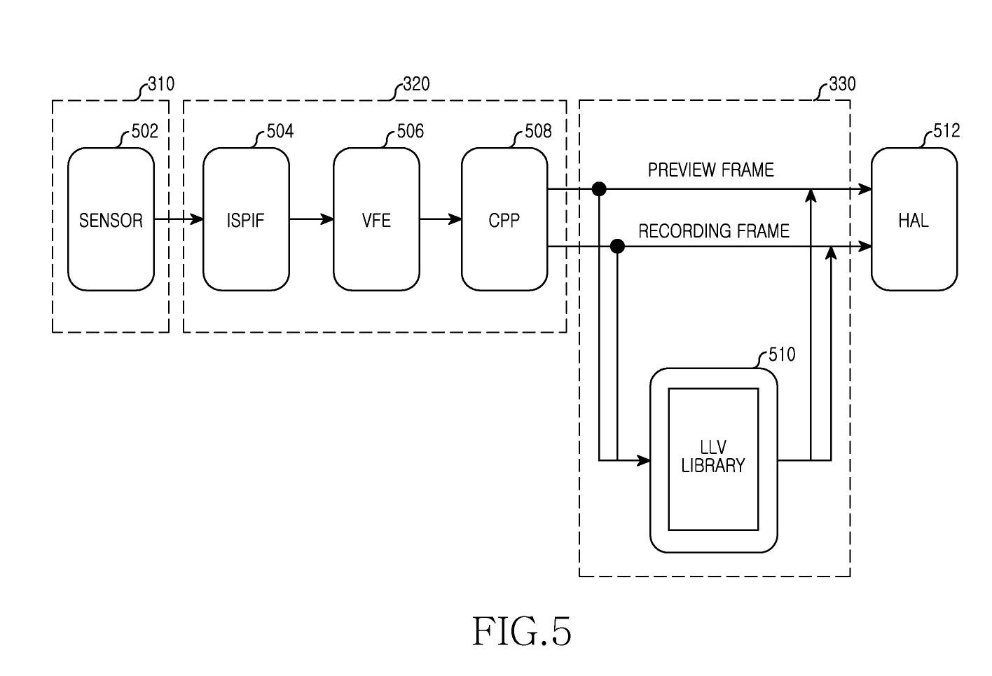

FIG. 5 is a block diagram illustrating low-illumination improvement processing in an electronic device according to an embodiment of the present disclosure.

Referring to FIG. 5, the sensing unit 310 may include a sensor 502. The pre-processor 320 may include an Image Signal Processing InterFace (ISPIF) 504, a Video Front End (VFE) 506, and a Camera Post Processing (CPP) 508. The low-illumination processor 330 may include an LLV library 510. An HAL 512 is further included.

As an element for recognizing a light beam which is input through a lens, the sensor 502 may further include at least one of CCD and CMOS. The ISPIF 504 provides an interface between the sensor 502 and its following processing blocks. The VFE 506 performs processing required for an image. For example, the required processing may include CSC, modification of a data contrast or brightness feature, reinforcement or modification of a light-on state regarding recorded data in a digital manner, compensation processing (e.g., white balancing, automatic gain control, and gamma correction), complex image processing (e.g., image filtering, etc.), and so on. The CPP 508 performs a function such as image scaling, etc., and provides a preview frame and a recording frame to each path. In this case, the CPP 508 may process the preview frame and the recording frame by using different codecs. The LLV library 510 includes a set of instructions for the low-illumination improvement processing described above in FIG. 1 and FIG. 2 or a hardware device which performs a computation according to the instruction. The HAL 512 performs a function for delivering video data to another hardware entity, and provides an environment in which other blocks can operate in a device-independent manner.

As illustrated in FIG. 5, a preview frame and a recording frame may be provided via different paths. In this case, if the low-illumination improvement processing is performed only on the preview frame, there is a difference between an image to be stored and the preview image. In other words, if the low-illumination improvement processing is performed only on the preview frame, the image to be stored consists of frames which are not subjected to the low-illumination improvement processing. Therefore, the LLV library 510 performs the same low-illumination improvement processing not only on the preview frame but also on the recording frame. Accordingly, the low-illumination improvement processing may be applied both on the preview frame and the recording frame. That is, the LLV library 510 receives preview frames and recording frames from the CPP 508, performs the low-illumination improvement processing, and thereafter outputs the result to the HAL 512 via each path. Thereafter, although not shown in FIG. 5, the HAL 512 outputs frames which are subjected to the low-illumination improvement processing by a display means and an encoding means.

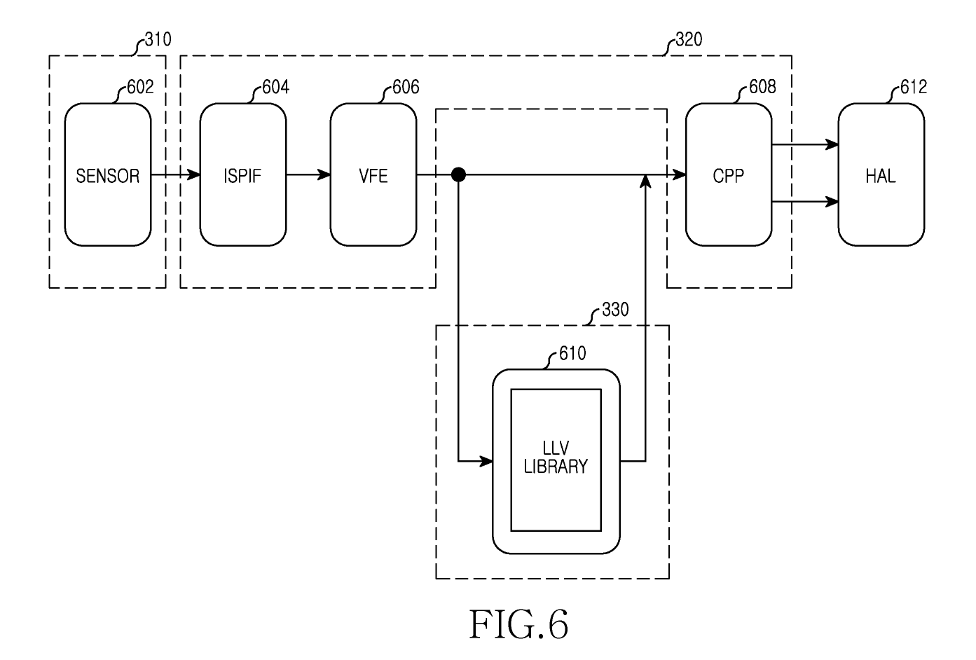

FIG. 6 is a block diagram illustrating low-illumination improvement processing in an electronic device according to an embodiment of the present disclosure.

Referring to FIG. 6, the sensing unit 310 may include a sensor 602. The pre-processor 320 may include an ISPIF 604, a VFE 606, and a CPP 608. The low-illumination processor 330 may include an LLV library 610. An HAL 612 may be further included.

As an element for recognizing a light beam which is input through a lens, the sensor 602 may further include at least one of a CCD and a CMOS. The ISPIF 604 may provide an interface between the sensor 602 and its following processing blocks. The VFE 606 performs processing required for an image. For example, the required processing may include CSC, modification of a data contrast or brightness feature, reinforcement or modification of a light-on state regarding recorded data in a digital manner, compensation processing (e.g., white balancing, automatic gain control, and gamma correction), complex image processing (e.g., image filtering, etc.), and so on. The CPP 608 performs a function such as image scaling, etc., and provides a preview frame and a recording frame to each path. In this case, the CPP 608 may process the preview frame and the recording frame by using different codecs. The LLV library 610 includes a set of instructions for the low-illumination improvement processing described above in FIG. 1 and FIG. 2 or a hardware device which performs a computation according to the instruction. The HAL 612 performs a function for delivering video data to another hardware entity, and provides an environment in which other blocks can operate in a device-independent manner.

As illustrated in FIG. 6, a preview frame and a recording frame may be provided via different paths. In this case, if the low-illumination improvement processing is performed only on the preview frame, there is a difference between an image to be stored and the preview image. Therefore, the LLV library 610 performs the low-illumination improvement processing on image data which is input to the CPP 608. Accordingly, the low-illumination improvement processing may be applied both on the preview frame and the recording frame. That is, the LLV library 610 receives frames from the VFE 606, performs the low-illumination improvement processing, and thereafter provides the processed frames to the CPP 608.

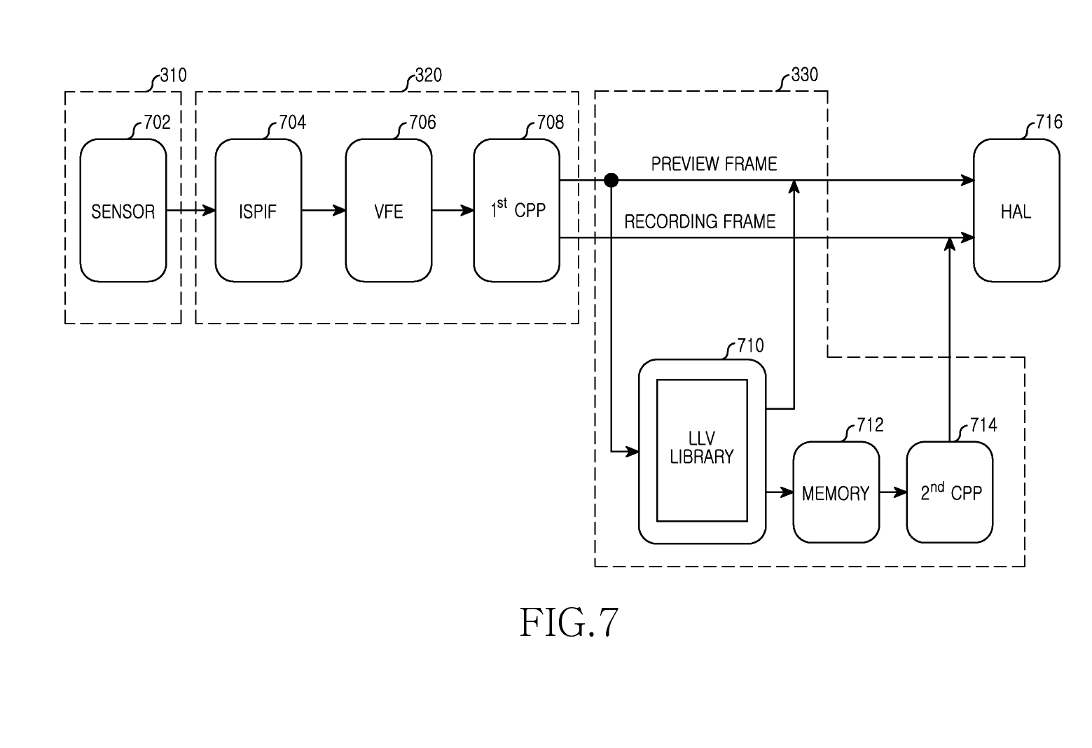

FIG. 7 is a block diagram illustrating low-illumination improvement processing in an electronic device according to an embodiment of the present disclosure.

Referring to FIG. 7, the sensing unit 310 may include a sensor 702. The pre-processor 320 may include an ISPIF 704, a VFE 706, and a 1^{st} CPP 708. The low-illumination processor 330 may include an LLV library 710, a memory 712, and a 2^{nd} CPP 714. An HAL 716 may be further included.

As an element for recognizing a light beam which is input through a lens, the sensor 702 may further include at least one of a CCD and a CMOS. The ISPIF 704 may provide an interface between the sensor 702 and its following processing blocks. The VFE 706 performs processing required for an image. For example, the required processing may include CSC, modification of a data contrast or brightness feature, reinforcement or modification of a light-on state regarding recorded data in a digital manner, compensation processing (e.g., white balancing, automatic gain control, and gamma correction), complex image processing (e.g., image filtering, etc.), and so on. The 1^{st} CPP 708 performs a function such as image scaling, etc., and provides a preview frame and a recording frame to each path. In this case, the 1^{st} CPP 708 may process the preview frame and the recording frame by using different codecs. The LLV library 710 includes a set of instructions for the low-illumination improvement processing described above in FIG. 1 and FIG. 2 or a hardware device which performs a computation according to the instruction. The HAL 716 performs a function for delivering video data to another hardware entity, and provides an environment in which other blocks can operate in a device-independent manner.

As illustrated in FIG. 7, a preview frame and a recording frame may be provided via different paths. In this case, if the low-illumination improvement processing is performed only on the preview frame, there is a difference between an image to be stored and the preview image. Therefore, the LLV library 710 outputs a path of the preview frames after performing the low-illumination improvement processing on the preview frames, and in addition thereto, outputs the processed preview frames via a path of the recording frame.

Unlike the embodiment of FIG. 5, in the embodiment of FIG. 7, the low-illumination improvement processing is performed only on the preview frame, and thus the processed frame cannot be directly used as the recording frame. Accordingly, the preview frames subjected to the low-illumination improvement processing are provided as the recording frame via the memory 712 and the 2^{nd} CPP 714. The memory 712 operates as a buffer for temporarily storing the preview frames subjected to the low-illumination improvement processing. The 2^{nd} CPP 714 performs processing performed on the recording frames in the 1^{st} CPP 708. In other words, the 2^{nd} CPP 714 performs processing for using a frame temporarily stored in the memory 712 as the recording frame. For example, the 2^{nd} CPP 714 scales the preview frame subjected to the low-illumination improvement processing according to an input of an encoder, and processes the frame by using a codec for the recording frame. Accordingly, the low-illumination improvement processing may be applied both on the preview frame and the recording frame.

According to the embodiment of FIG. 7, the LLV library 710 performs the low-illumination improvement processing on the preview frame, and thereafter provides a copied frame to a path for the recording frame. However, according to another embodiment of the present disclosure, the LLV library 710 may perform the low-illumination improvement processing on the recording frame, and thereafter may provide the recording frame subjected to the low-illumination improvement processing to a path for the preview frame. In this case, the 2^{nd} CPP 714 performs processing performed on the preview frames.

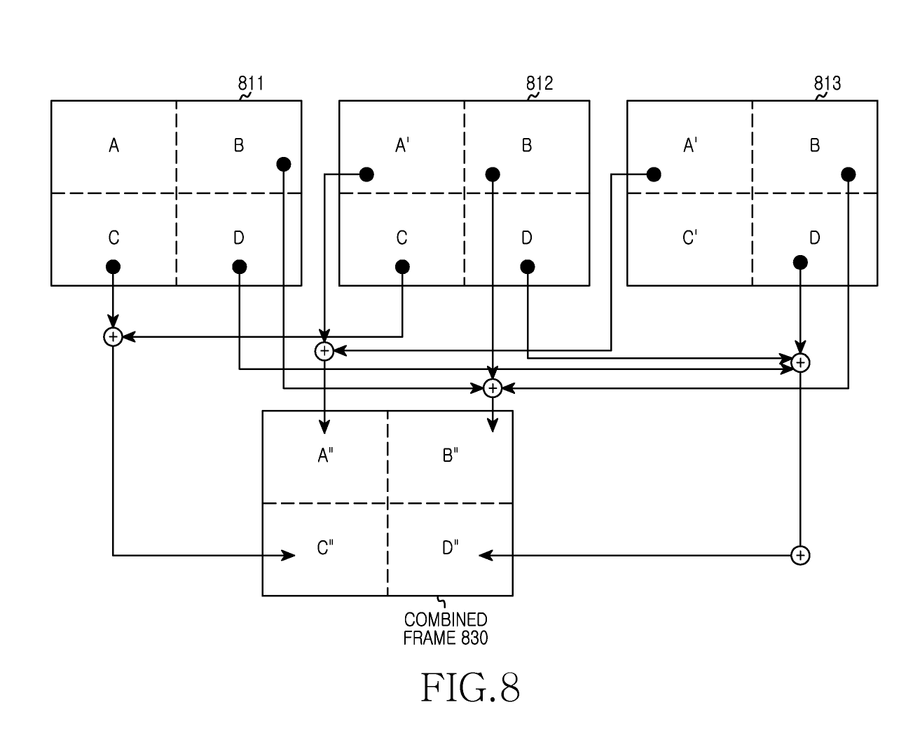

As described above, the electronic device according to an embodiment of the present disclosure may perform the low-illumination improvement processing in video recording. As described above, the low-illumination improvement processing can increase a brightness of an image, which is achieved by combining a plurality of frames. In this case, unlike image processing performed on a single image in a still camera, it is not guaranteed that frames combined according to an embodiment of the present disclosure include the same image. This is because, since frames to be combined are preview frames, an image is also changed if a subject moves. Accordingly, the combination of the frames may require another mechanism different from the combination for quality improvement of the single image. For example, the combination may be performed except for an area where a motion exists in the image, and an example thereof is as illustrated in FIG. 8.

FIG. 8 illustrates an example of combining a frame in an electronic device according to an embodiment of the present disclosure.

Referring to FIG. 8, a frame 830 is subjected to low-illumination processing on the basis of three frames 811, 812, and 813. Each of the frames 811, 812, and 813 is split into four areas. The four areas include an area A, an area B, an area C and an area D. In case of the area A, a motion exists between the 1^{st} frame 811 and the 2^{nd} frame 812, and there is no motion between the 2^{nd} frame 812 and the 3^{rd} frame 813. Therefore, in the frame 830 subjected to the low-illumination processing, the area A is generated on the basis of the 2^{nd} frame 812 and the 3^{rd} frame 813. In case of the area C, there is no motion between the 1^{st} frame 811 and the 2^{nd} frame 812, and a motion exists between the 2^{nd} frame 812 and the 3^{rd} frame 813. Accordingly, in the frame 830 subjected to the low-illumination processing, the area C is generated on the basis of the 1^{st} frame 811 and the 2^{nd} frame 812. In the cases of the area B and the area D, there is no motion among all of the frames 811, 812, and 813. Accordingly, in the frame 830 subjected to the low-illumination processing, the area B and the area D are generated on the basis of all of the frames 811, 812, and 813.

The frames illustrated in FIG. 8 are split into four square areas for convenience of description. However, the frame may be split into other areas in different numbers and in different shapes.

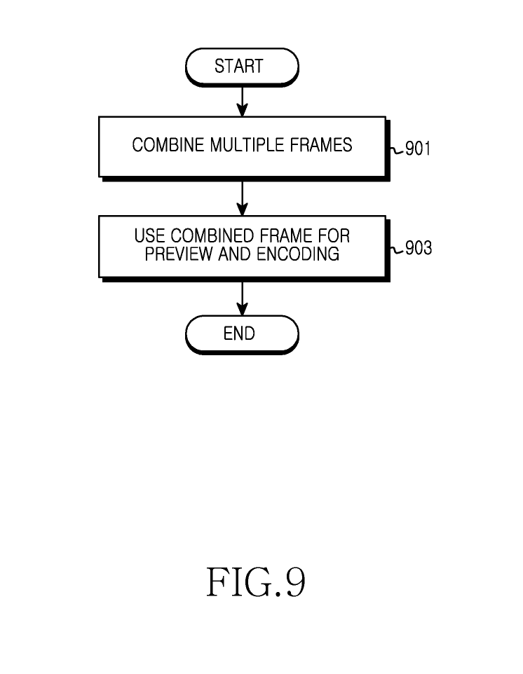

FIG. 9 illustrates a process of operating an electronic device according to an embodiment of the present disclosure.

Referring to FIG. 9, the electronic device combines a plurality of frames into a single frame in operation 901. Herein, the frame includes an individual single image obtained from a moving image. The combined frame may be a preview frame and a recording frame. The combination is performed to increase a brightness of the image. However, in case of video frames, images included in each frame may differ from each other, and thus other methods may also be applied in addition to simply combining all frames. For example, the electronic device may perform the combination by using only areas including the same image between frames. Although not shown in FIG. 9, the electronic device may further perform noise removal on the combined frame.

In operation 903, the electronic device uses the combined frame for preview and encoding. In other words, the electronic device displays the combined frame by using a display means in a format of video being recorded, and encodes the combined frame according to a format for recording. The encoded image may be stored in a storage means. In this case, to preview and encode the combined frame, various processing mechanisms may be applied. If a preview frame and a recording frame are processed on the same path, the electronic device may combine the frame on a path on which the frame is processed. On the other hand, if the preview frame and the recording frame are processed on different paths, the electronic device may combine the frames before the paths are branched off. According to an embodiment of the present disclosure, the electronic device may perform an operation of combining the frames in an overlapping manner on each of the two paths. According to an embodiment of the present disclosure, the electronic device may combine preview frames extracted on one path, may copy the combined preview frame, and thereafter may output the result on a path of a recording frame. According to an embodiment of the present disclosure, the electronic device may combine recording frames extracted on one path, may copy the combined recording frame, and thereafter may output the result on a path of the preview frame.

The method described above in relation with FIG. 9 under of the present invention may be provided as one or more instructions in one or more software modules, or computer programs stored in an electronic device including a portable terminal.

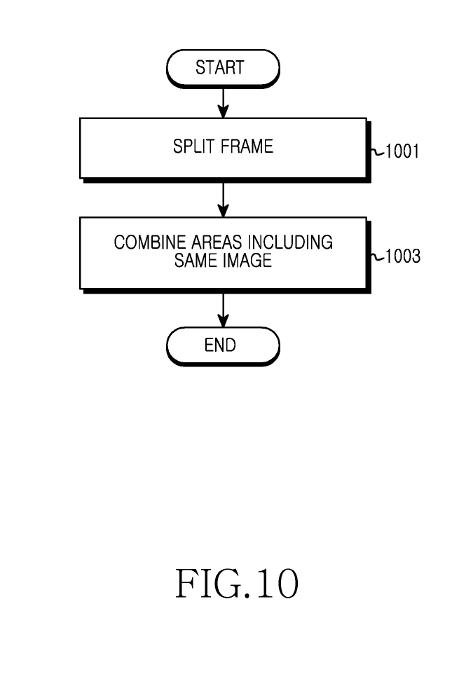

FIG. 10 illustrates a process of operating an electronic device according to an embodiment of the present disclosure.

Referring to FIG. 10, the electronic device splits a frame into a plurality of areas in operation 1001. That is, the electronic device splits each of the plurality of frames to be combined for low-illumination improvement processing. In this case, the splitting may be performed according to a pre-defined pattern, or may be performed on the basis of an area where a motion exists in an image in the frame. For example, the electronic device may split the frames by distinguishing an area where a motion exists from an area where no motion exists in the image in the frames.

In operation 1003, the electronic device combines areas which include the same image. In other words, the electronic device increases a brightness of a corresponding area by combining areas where no motion exists between different frames among the split areas. In this case, when considering only a specific area, if there is no motion only between some frames among a plurality of frames to be combined, the combination on the specific area is performed by using only frames not having a motion. That is, the number of frames to be used in the combination may vary depending on the area.

The method described above in relation with FIG. 10 under of the present invention may be provided as one or more instructions in one or more software modules, or computer programs stored in an electronic device including a portable terminal.

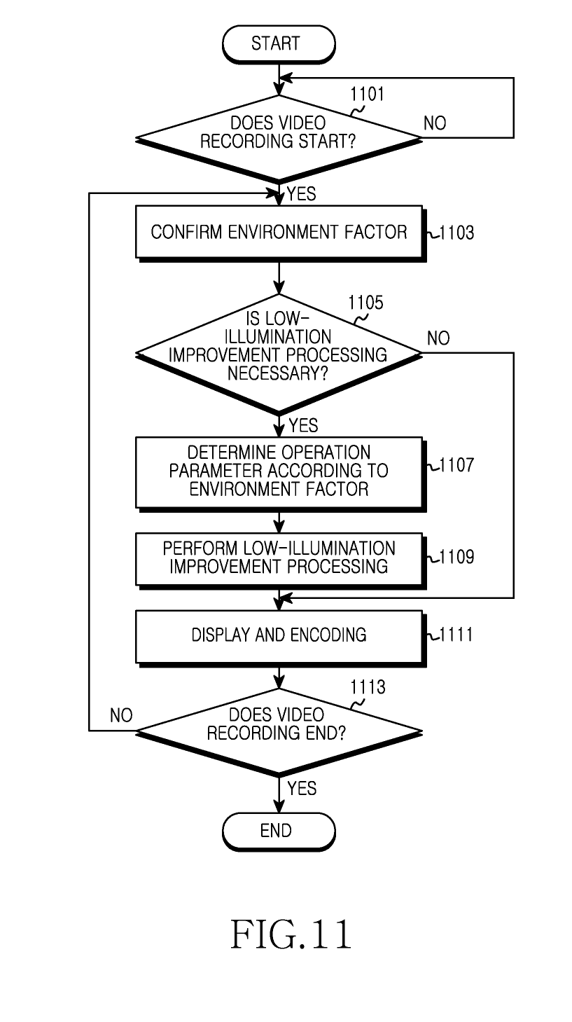

FIG. 11 is a flowchart illustrating an operation of an electronic device according to an embodiment of the present disclosure.

Referring to FIG. 11, the electronic device determines whether video recording starts in operation 1101. The video recording may start by a user's manipulation or at the occurrence of a pre-defined event.

When the video recording starts, proceeding to operation 1103, the electronic device confirms an environment factor. For example, the environment factor may include at least one of an exposure value of an input image, a temperature, and whether there is a motion of a subject. Herein, the temperature includes a level of heat generation of the electronic device. In other words, the electronic device collects information of the exposure value, temperature, motion state, etc., during the video recording. For this purpose the electronic device may include a temperature sensor.

After the environment factor is confirmed, in operation 1105 the electronic device determines whether low-illumination improvement processing is necessary. Whether the low-illumination improvement processing is necessary may be determined on the basis of the environment factor. For example, if the exposure value of the image is greater than or equal to a threshold or if the temperature is greater than or equal to a threshold, the electronic device may determine that the low-illumination improvement processing is not necessary. If it is determined that the low-illumination improvement processing is not necessary, the procedure proceeds to operation 1111 described below.

If it is determined that the low-illumination improvement processing is necessary, in operation 1107 the electronic device determines an operation parameter according to the environment factor. That is, in the low-illumination improvement processing, not only a simple on/off step but also a processing level may be controlled in a stepwise manner. For example, as the processing level, at least one of the number of frames used in the combination, a level of noise removal (e.g., whether to perform noise removal, a filter window size, the number of frames to be used in temporal noise removal, etc.), and a quantity of exposure reinforcement may be controlled. For another example, the level of the low-illumination improvement processing may be decreased when the temperature, i.e., heat generation of the electronic device, is high, when the exposure value is high, or when the subject moves more than a threshold amount. For another example, if the subject moves, the noise removal may be omitted. That is, if the subject moves more than the threshold amount, a computation amount is increased since an image difference is relatively increased between frames. Thus, an unnecessary computation is decreased by decreasing the processing level.

In operation 1109 the electronic device performs the low-illumination improvement processing according to the determined operation parameter. According to an embodiment of the present disclosure, the low-illumination improvement processing may include image splitting, exposure reinforcement, and noise removal. However, according to the determination result of the operation parameter, the noise removal may be excluded. The exposure reinforcement is performed by combining frames. The frame to be combined may be a preview frame, or may be the preview frame and a recording frame. However, in the case of video frames, images included in each frame may differ from one another, and thus another mechanism may be applied other than a mechanism of simply combining all of the frames.

In operation 1111 the electronic device displays and encodes a preview screen by using a frame subjected to the low-illumination improvement processing. An encoded image may be stored in a storage means, or may be transmitted to an external element via a communication means. If it is determined in operation 1105 that the low-illumination improvement processing is not necessary, the electronic device displays the generated preview frame in the preview screen, and encodes a recording frame.

In operation 1113 the electronic device determines whether the video recording ends. The video recording may end by a user's manipulation or at the occurrence of a pre-defined event. If the video recording continues, the electronic device continually monitors the environment factor in operation 1103, and repeats the operations 1105 to 1111.

The method described above in relation with FIG. 11 under of the present invention may be provided as one or more instructions in one or more software modules, or computer programs stored in an electronic device including a portable terminal.

The present invention may be implemented in an electronic device including a portable terminal such as, for example, a smart phone and a mobile telecommunication terminal.

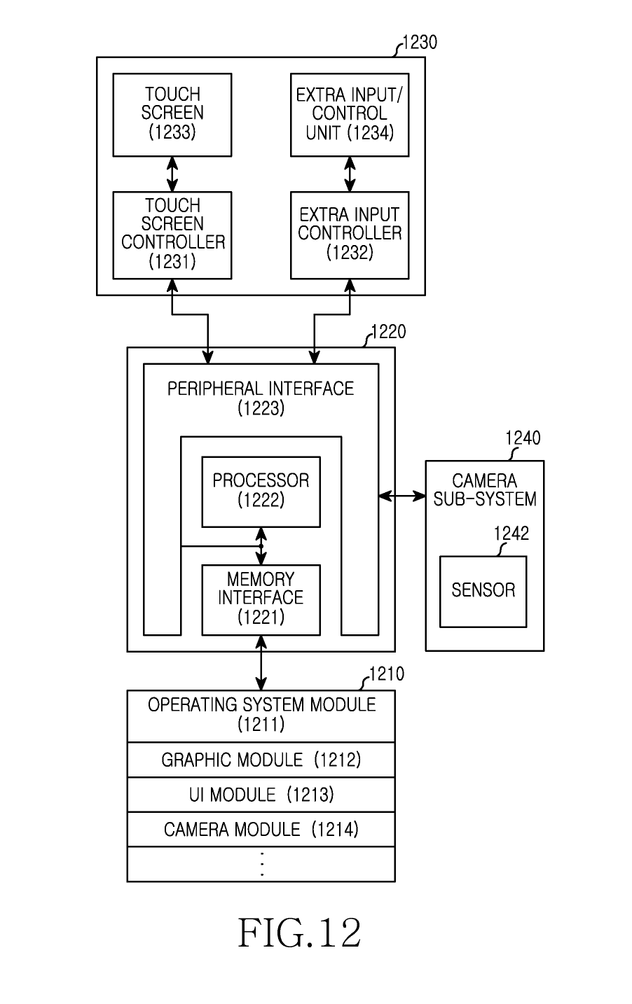

FIG. 12 is a block diagram of an electronic device according to an embodiment of the present disclosure.

Referring to FIG. 12, the electronic device includes a memory 1210, a processor unit 1220, an input/output system 1230, and a camera sub-system 1240. The memory 1210 may be plural in number.

The memory 1210 stores at least one of software, microcode, configuration information, etc. The memory 1210 may include at least one of a fast random access memory such as one or more magnetic disc storage devices, a non-volatile memory, one or more optical storage devices, and a flash memory (e.g., NAND, NOR). The memory 1210 may include an operating system module 1211, a communication module (not shown), a graphic module 1212, a User Interface (UI) module 1213, a camera module 1214, at least one application module (not shown), etc. In addition, a module which is a software constitutional element may be expressed as a set of instructions, and the module may be referred to as an ‘instruction set’ or a ‘program’.

The operating system module 1211 may include an instruction set for controlling a general system operation. For example, the operating system module 1211 may be a built-in operating system such as WINDOWS, LINUX, Darwin, RTXC, UNIX, OS X, VxWorks, Android, iOS, etc. For example, the operating system module 1211 controls the general system operation such as memory management and control, storage hardware control and management, power control and management, etc. The operating system module 1211 performs a function for facilitating communication between at least one hardware constitutional element and at least one software constitutional element.

The graphic module 1212 may include at least one instruction set for providing and displaying a graphic on a touch screen 1233. Herein, the graphic may include a text, a web page, an icon, a digital image, a video, an animation, etc. Since the touch screen 1233 displays an image, it may be referred to as a ‘display unit’.

The UI module 1213 may include at least one instruction set for providing a user interface. For example, the UI module 1213 provides control as to how a state of the user interface is changed or in what condition the user interface state is changed, etc.

The camera module 1214 may include at least one instruction set for performing camera-related processes and functions.

The memory 1210 may include one or more additional modules in addition to the aforementioned modules 1211 to 1214. Alternatively, some of the aforementioned modules 1211 to 1214 may be excluded.

The processor unit 1220 may include a memory interface 1221, a processor 1222, and a peripheral interface 1223. Optionally, the processor unit 1220 may be collectively called a ‘processor’. The memory interface 1221, the processor 1222, and the peripheral interface 1223 may be separate constitutional elements or may be constructed with at least one integrated circuit.

The processor 1222 may include at least one hardware chip. The processor 1222 executes a software module to perform a function implemented by the software module. In particular, the processor 1222 interworks with software modules stored in the memory 1210 to perform embodiments of the present disclosure. In addition, the processor 1222 may include at least one data processor and image processor. According to another embodiment of the present disclosure, the data processor and the image processor may be configured with separate hardware entities. In addition, the processor 1222 may be configured with a plurality of processors for performing different functions. The processor 1222 may be referred to as an ‘AP’.

The memory interface 1221 provides a transfer path of data and control signals between the memory 1210 and the processor 1222. For example, the memory 1221 provides an interface for accessing to the memory 1210. The peripheral device interface 1223 couples the input/output system 1230 of the electronic device and at least one peripheral device to the processor 1221 and the memory 1210.

The input/output system 1230 may include a touch screen controller 1231, an extra input controller 1232, the touch screen 1233, and an extra input/control unit 1234.

The touch screen controller 1231 may be coupled to the touch screen 1233. The touch screen 1233 and the touch screen controller 1231 are not limited thereto, and thus can use not only capacitive, resistive, infrared ray, and surface acoustic wave techniques for determining at least one contact point on the touch screen 1233 but also a multi-touch sensing technique including extra proximity sensor arrangement or extra elements, so as to detect a contact, a motion, an interruption of the contact or the motion.

The extra input controller 1232 may be coupled to the extra input/control unit 1234. An up/down button for at least one volume control may be included in the extra input/control unit 1234. In addition, the button may have a form of a push button or a pointer device such as a rocker button, a rocker switch, a thumb-wheel, a dial, a stick, a stylus, etc.

The touch screen 1233 provides an input/output interface between the electronic device and a user. For example, the touch screen 1233 delivers a touch input of the user to the electronic device. In addition, the touch screen 1233 is a medium which shows an output from the electronic device to the user. For example, the touch screen 1233 shows a visual output to the user. The visual output is expressed in a form of one or more of a text, a graphic, a video, and a combination of the foregoing. Various display elements may be used for the touch screen 1233. For example, although not limited thereto, the touch screen 1233 may include at least one of LCD, LED, LPD, OLED, AMOLED, and FLED.

The camera sub-system 1240 may perform photographing, video recording, etc. The camera sub-system 1240 may include an optical sensor 1242, a lens, etc. At least one of a CCD and a CMOS may be used as the optical sensor 1242. For example, the camera sub-system 1240 recognizes a light beam input through the lens by using the optical sensor 1242, and digitizes an image recognized in the optical sensor 1242 into data.

According to an embodiment of the present disclosure, the processor 1222 performs the low-illumination improvement processing during the video recording. For this, the processor 1222 may include a hardware block for the low-illumination improvement processing. According to another embodiment of the present disclosure, the memory 1210 may store a software module for the low-illumination improvement processing, and the processor 1222 may execute the software module. That is, the processor 1222 performs the procedures of FIG. 9 to FIG. 11. According to another embodiment, an additional hardware block may be provided for the low-illumination improvement processing. According to another embodiment, a function for the low-illumination improvement processing may be implemented by the processor 1222 and an additional processor in a distributed manner.

According to an embodiment of the present disclosure, the processor 1222 increases a brightness of an image by combining a plurality of frames. In this case, the processor 1222 may further perform noise removal on the combined frame. In addition, the processor 1222 uses the combined frame for preview and encoding. That is, the touch screen 1233 displays the combined frame on the preview screen.

According to another embodiment of the present disclosure, the processor 1222 splits each of the plurality of frames to be combined for the low-illumination improvement processing. In this case, the splitting may be performed according to a pre-defined pattern, or may be performed on the basis of an area where a motion exists in an image in the frame. Thereafter, the processor 1222 increases a brightness of a corresponding area by combining areas where no motion exists between different frames among the split areas. In this case, when considering only a specific area, if there is no motion only between some frames among a plurality of frames to be combined, the combination on the specific area is performed by using only the frames not having motion between them.

According to another embodiment of the present disclosure, the processor 1222 collects environment factor information when the video recording starts. For example, the environment factor may include at least one of an exposure value of an input image, a temperature, and whether there is a motion of a subject. The electronic device may include a temperature sensor. Thereafter, the processor 1222 determines whether the low-illumination improvement processing is necessary on the basis of the environment factor, and determines an operation parameter according to the environment factor. Subsequently, the processor 1222 performs the low-illumination improvement processing according to the determined operation parameter, and thereafter displays and encodes a preview screen by using a frame subjected to the low-illumination improvement processing.

Various functions of the electronic device according to the present disclosure may be executed by at least one of stream processing, a hardware and software entity including an Application Specific Integrated Circuit (ASIC), and a combination of them.

A bright image can be obtained at low illumination both in a preview screen and an encoding/recording screen by combining a plurality of frames when video recording is performed in an electronic device. Further, effective image processing can be performed by controlling operation parameters for low-illumination improvement processing on the basis of an environment analysis.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a Compact Disc (CD), Digital Video Disc (DVD), magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

In the aforementioned various embodiments of the present disclosure, a constitutional element included in the disclosure may have been expressed in a singular or plural form according to the embodiment being described. However, the singular or plural expression is selected properly for a situation proposed for the convenience of explanation, and thus the disclosure is not limited to a single or a plurality of constitutional elements. Therefore, a constitutional element expressed in a plural form can also be expressed in a singular form, or vice versa.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method in an electronic device, the method comprising:
combining a plurality of frames of video being recorded;
displaying the combined frame via a preview screen; and
encoding the combined frame.

2. The method of claim 1, wherein the combined frames include frames generated for the preview screen.

3. The method of claim 1, wherein the combining of the plurality of frames comprises generating the combined frame during the video recording.

4. The method of claim 1, wherein the combining of the plurality of frames comprises:
selecting a number of input frames among frames generated continuously during the video recording; and
generating one output frame on the basis of the input frames included in the number.

5. The method of claim 4, wherein the selecting of the input frames comprises:
selecting a first input frame set at a first time point; and
selecting a part of the first input frame set and at least one different input frame at a second time point.

6. The method of claim 1, wherein the combining of the plurality of frames comprises outputting the combined frame on a path for a preview frame and a recording frame.

7. The method of claim 1, wherein the combining of the plurality of frames comprises:
combining frames extracted on a first path for a preview frame, and outputting the combined frame on the first path; and
combining frames extracted on a second path for a recording frame, and outputting the combined frame on the second path.

8. The method of claim 1, wherein the combining of the plurality of frames comprises:
combining frames extracted on a first path for a preview frame;
outputting the combined frame on the first path;
copying the combined frame; and
outputting the copied frame on a second path for a recording frame.

9. The method of claim 8, wherein the combining of the plurality of frames comprises performing a process of using the copied frame as the recording frame.

10. The method of claim 1, wherein the combining of the plurality of frames comprises:
splitting each of the plurality of frames into a plurality of areas; and
combining corresponding areas where no motion exists between different frames.

11. The method of claim 1, further comprising determining whether the frames are combined on a basis of an environment factor, wherein the environment factor includes at least one of an exposure value of an input image, a temperature, and whether there is motion of a subject.

12. The method of claim 1, further comprising determining an operation parameter for combining the frames on a basis of an environment factor,
wherein the environment factor includes at least one of an exposure value of an input image, a temperature, and whether there is motion of a subject, and
wherein the operation parameter includes at least one of a number of frames used in the combination, whether to perform noise removal, a filter window size for the noise removal, a number of frames to be used in temporal noise removal, and a quantity of exposure reinforcement.

13. The method of claim 12, wherein the operation parameter is determined such that a higher temperature produces a corresponding lower level of the combination.

14. The method of claim 12, wherein the operation parameter is determined such that a higher exposure value produces a corresponding lower level of the combination.

15. The method of claim 12, wherein the operation parameter is determined such that a greater motion of the subject produces a lower level of the combination.

16. The method of claim 12, wherein the operation parameter is determined not to perform the noise removal if the subject moves.

17. The method of claim 1, further comprising performing noise removal on the combined frame.

18. An electronic device capable of video recording, the electronic device comprises:
a processor configured to combine a plurality of frames of video being recorded, and to encode the combined frame; and
a display unit configured to display the combined frame via a preview screen.

19. The electronic device of claim 18, wherein the combined frames include frames generated for the preview screen.

20. The electronic device of claim 18, wherein the processor generates the combined frame during the video recording.

21. The electronic device of claim 18, wherein the processor selects a number of input frames among frames generated continuously during the video recording, and generates one output frame on the basis of the input frames included in the number.

22. The electronic device of claim 21, wherein the processor selects a first input frame set at a first time point, and selects a part of the first input frame set and at least one different input frame at a second time point.

23. The electronic device of claim 18, wherein the processor outputs the combined frame on a path for a preview frame and a recording frame.

24. The electronic device of claim 18, wherein the processor combines frames extracted on a first path for a preview frame, outputs the combined frame on the first path, combines frames extracted on a second path for a recording frame, and outputs the combined frame on the second path.

25. The electronic device of claim 18, wherein the processor combines frames extracted on a first path for a preview frame, outputs the combined frame on a first path, copies the combined frame, and outputs the copied frame on a second path for a recording frame.

26. The electronic device of claim 25, wherein the processor performs a process of using the copied frame as the recording frame.

27. The electronic device of claim 18, wherein the processor splits each of the plurality of frames into a plurality of areas, and combines corresponding areas where no motion exists between different frames.

28. The electronic device of claim 18,
wherein the processor determines whether the frames are combined on a basis of an environment factor, and
wherein the environment factor includes at least one of an exposure value of an input image, a temperature, and whether there is motion of a subject.

29. The electronic device of claim 18,
wherein the processor determines an operation parameter for combining the frames on a basis of an environment factor,
wherein the environment factor includes at least one of an exposure value of an input image, a temperature, and whether there is motion of a subject, and
wherein the operation parameter includes at least one of a number of frames used in the combination, whether to perform noise removal, a filter window size for the noise removal, a number of frames to be used in temporal noise removal, and a quantity of exposure reinforcement.

30. The electronic device of claim 29, wherein the operation parameter is determined such that a higher temperature produces a corresponding lower level of the combination.

31. The electronic device of claim 29, wherein the operation parameter is determined such that a higher exposure value produces a corresponding lower level of the combination.

32. The electronic device of claim 29, wherein the operation parameter is determined such that a greater motion of the subject produces a corresponding lower level of the combination.

33. The electronic device of claim 29, wherein the operation parameter is determined not to perform the noise removal if the subject moves.

34. The electronic device of claim 18, wherein the processor performs noise removal on the combined frame.

35. An electronic device configured to record video, the electronic device comprising:
at least one processor; and
a memory configured to store a software module executed by the at least one processor,
wherein the software module includes an instruction set for combining a plurality of frames of video being recorded, for displaying the combined frame via a preview screen, and for encoding the combined frame.
